(19) United States
(12) Patent Application Publication
(10) Pub. No.: US 2021/0023746 A1
(43) Pub. Date: Jan. 28, 2021

(54) RESIN MOLDED ARTICLE AND METHOD FOR PRODUCING RESIN MOLDED ARTICLE

(71) Applicant: PACIFIC INDUSTRIAL CO., LTD., Ogaki-shi, Gifu-ken (JP)

(72) Inventors: Yuya FUKUI, Fuwa-gun (JP); Yoshinari NAITO, Ogaki-shi (JP); Shinichi FURUNO, Ogaki-shi (JP)

(73) Assignee: PACIFIC INDUSTRIAL CO., LTD., Ogaki-shi, Gifu-ken (JP)

(21) Appl. No.: 16/628,178

(22) PCT Filed: Apr. 17, 2019
(86) PCT No.: PCT/JP2019/016418

§ 371 Date: Jan. 2, 2020

(30) Foreign Application Priority Data
Sep. 21, 2018 (JP) 2018-178033

(51) Int. Cl. B29C 43/20; B29C 43/34; B29C 70/22; B29C 70/42

(52) U.S. Cl. CPC B29C 43/203; B29C 70/42; B29C 70/22; B29C 43/34

(57) ABSTRACT

The method includes placing a block-shaped second resin on a backside of a composite sheet within outer edges, the composite sheet being made up of a plurality of stacked fiber sheets impregnated with a first resin and pressing the composite sheet and the second resin by a heated mold, to produce a resin molded article having the composite sheet embedded in a part of a surface of a resin layer of the second resin that extends to sides of the composite sheet. The composite sheet is formed such that a first fiber sheet of the plurality of fiber sheets positioned closest to a front side of the composite sheet is larger than other fiber sheets and covers the other fiber sheets entirely from the front side, when placed inside the mold.

### TECHNICAL FIELD

The present disclosure relates to a resin molded article containing fibers and a method for producing the same.

### BACKGROUND ART

A resin molded article of this type made up of a fiber sheet impregnated with a first resin and a second resin molded over the backside of the fiber sheet has been known before, wherein the second resin extends over the sides of the fiber sheet (see, for example, Patent Document 1).

### RELATED ART DOCUMENTS

### Patent Documents

Patent Document 1: Japanese Patent No. 5064981 (FIG. 2)

### SUMMARY OF INVENTION

### Technical Problems

When a plurality of fiber sheets are stacked upon one another, the fiber sheets could be displaced during the molding, in which case the end faces of the fiber sheets on the deeper side and loose fibers sticking out from the end faces will show on the surface of the resin molded article, thereby degrading the appearance of the boundary part between materials. In view of this, it is desired to improve the appearance of the boundary part between materials.

### Means of Solving the Problems

The present disclosure resides in a method for producing a resin molded article. The method includes placing a block-shaped second resin on a backside of a composite sheet within outer edges, the composite sheet being made up of a plurality of stacked fiber sheets impregnated with a first resin and pressing the composite sheet and the second resin by a heated mold, to produce a resin molded article having the composite sheet embedded in a part of a surface of a resin layer of the second resin that extends to sides of the composite sheet. The composite sheet is formed such that a first fiber sheet of the plurality of fiber sheets positioned closest to a front side of the composite sheet is larger than other fiber sheets and covers the other fiber sheets entirely from the front side, when placed inside the mold.

The present disclosure resides in a resin molded article. The article includes a composite sheet made up of a plurality of stacked fiber sheets impregnated with a first resin. The composite sheet is embedded in a part of a surface of a resin layer of a second resin that extends to sides of the composite sheet. A first fiber sheet of the plurality of fiber sheets positioned closest to a front side of the composite sheet is larger than other fiber sheets. The article further includes a textured part that is a band-like region having surface irregularities and extending along and including a boundary of outer edges of the composite sheet in a surface of the resin molded article.

### BRIEF DESCRIPTION OF THE DRAWINGS

FIG. 1 is a cross-sectional view of a vehicle to which an engine undercover according to the present disclosure is mounted.

FIG. 2 is a plan view of the engine undercover.

FIG. 3 is a cross-sectional view of the engine undercover.

FIG. 4 is a cross-sectional view of a fiberglass cloth.

FIG. 5 is a cross-sectional view illustrating a production step of the engine undercover.

FIG. 6(A) is a conceptual diagram of a conventional engine undercover, and FIG. 6(B) is a conceptual diagram of the conventional engine undercover in which fiberglass cloths have displaced.

FIG. 7 is a conceptual diagram of an engine undercover in which fiberglass cloths have displaced.

FIG. 8 is a cross-sectional view of an engine undercover according to a modified example.

FIG. 9 is a cross-sectional view illustrating a production step of the engine undercover according to a modified example.

### MODE FOR CARRYING OUT THE INVENTION

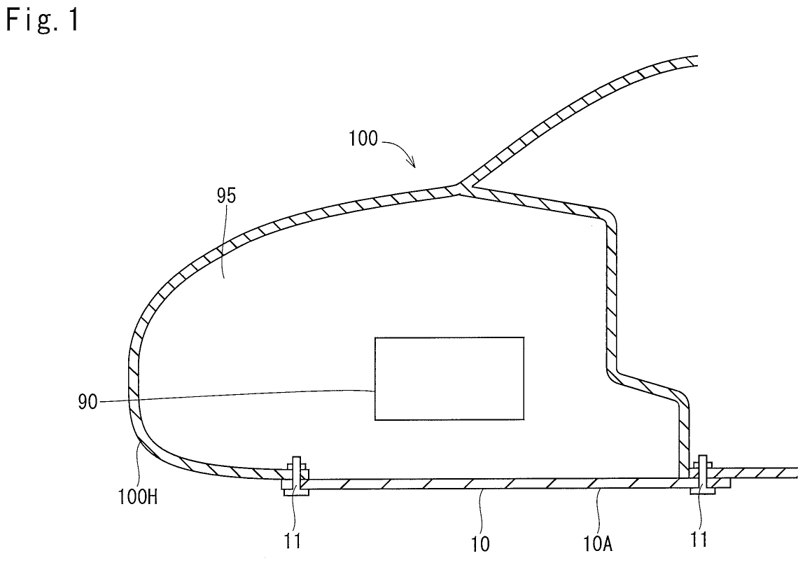

FIG. 1 shows an engine undercover 10 as a resin molded article of the present disclosure. The engine undercover 10 is located directly below an engine room 95 of a vehicle 100 and covers the engine 90 from below. The engine undercover 10 is fastened to a body of the vehicle 100H with bolts. Bolt holes 11 for the bolts to be fastened is formed in the engine undercover 10.

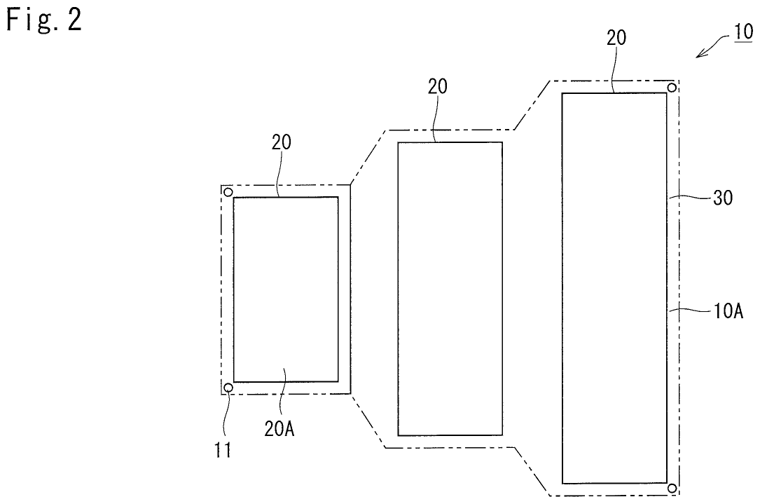

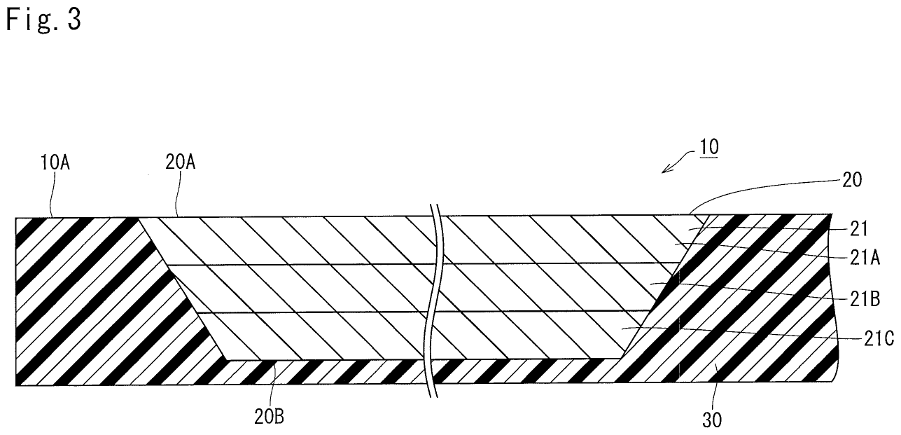

FIG. 2 is a plan view of a first side 10A of the engine undercover 10, one of the two sides that is a lower side of the engine undercover 10 (i.e., facing outward of the vehicle 100), and FIG. 3 is a cross-sectional side view of the engine undercover 10. Hereinafter, the first side 10A of the engine undercover 10 shall be the front side of the engine undercover 10 and the opposite side from the first side 10A shall be the backside. As shown in FIG. 2 and FIG. 3, the engine undercover 10 has a rectangular plate-like composite sheet 20 embedded in the surface of a resin layer 30 extending over the sides of the composite sheet 20.

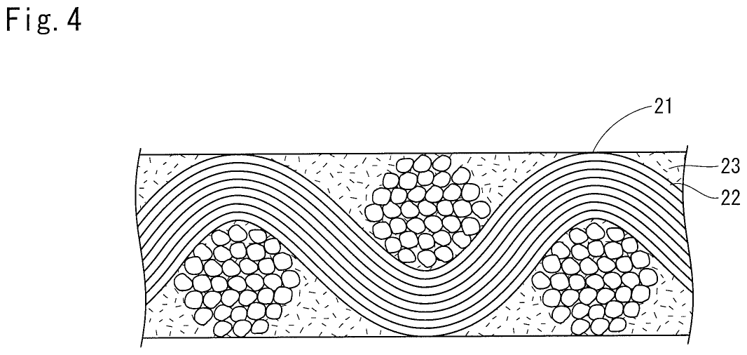

The resin layer 30 is made of a thermoplastic resin with fine glass fibers (not shown) dispersed therein. The composite sheet 20 is made of three fiberglass cloths 21 plain-woven from glass threads 22 that are bundles of glass fibers (see FIG. 4), which are superposed upon one another and made in one piece by a thermoplastic resin 23 that impregnates the fiberglass cloths 21 as shown in FIG. 3. The thermoplastic resin used as the resin 23 of the composite sheet 20 or the resin layer 30 is polypropylene (PP), for example.

As shown in FIG. 4, the composite sheet 20 of the engine undercover 10 in this embodiment has outer edges inclined with respect to the front side 20A and the backside 20B so that the front side 20A of the composite sheet 20 is larger than the backside 20B. Thus, the first fiberglass cloth 21A positioned closest to the front side 20A of the three fiberglass cloths 21 is larger than the second and third fiberglass cloths 21B and 21C positioned on its backside.

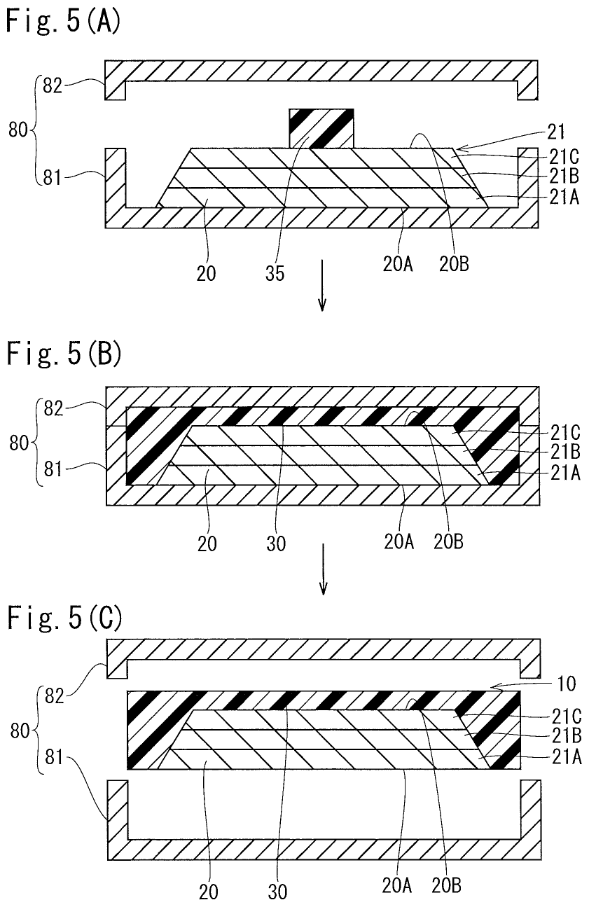

Next, a method for producing the engine undercover 10 will be described with reference to FIG. 5. First, the composite sheet 20 is prepared. The composite sheet 20 is produced, for example, by impregnating three layered fiberglass cloths 21 with the resin 23 to make them in one piece and by cutting the cloths diagonally all around the outer edges. The composite sheet 20 is cut, for example, with a water jet or a laser.

The composite sheet 20 is set in a lower part 81 of a mold 80, with the front side 20A facing down (i.e., the first fiberglass cloth 21A facing down), upon which a resin block 35 that will become the resin layer 30 is placed, as shown in FIG. 5(A). At this time, as shown in the drawing, the first fiberglass cloth 21A covers the second and third fiberglass cloths 21B and 21C entirely from the front side 20A (from below in FIG. 5).

Next, an upper part 82 of the mold 80 is moved down to close the mold 80 as shown in FIG. 5(B), and heat and pressure are applied. The thermoplastic resin of the resin block 35 is then softened or melted and spreads to the sides of the composite sheet 20 and forms the resin layer 30.

The mold 80 is then cooled down. When the resin layer 30 and the resin 23 of the composite sheet 20 are hardened, the mold 80 is opened, and the completed engine undercover 10 is taken out (see FIG. 5(C)). This is a method for producing the engine undercover 10.

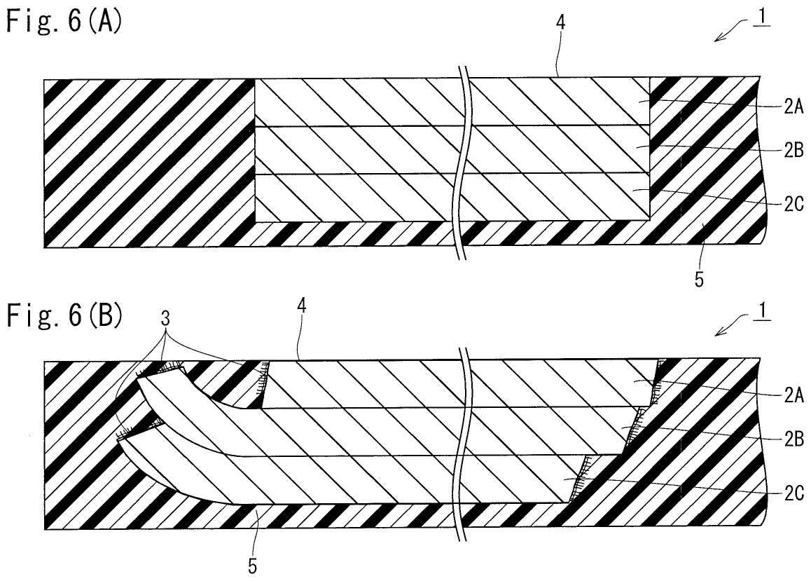

When the thermoplastic resin of the resin block 35 is softened or melted and spreads to the sides of the composite sheet 20, the fiberglass cloth 21 of the composite sheet 20 on the deeper side (upper side in FIG. 5) could be dragged by the flow of the thermoplastic resin of the resin block 35 and displaced. When this happens, in the conventional engine undercover 1 shown in FIG. 6(A), the fiberglass cloths 2B and 2C on the deeper side stick out from the fiberglass cloth 2A on the front side as shown in FIG. 6(B), with the end faces of the fiberglass cloths 2B and 2C on the deeper side or loose glass threads 3 from the end faces showing on the surface of the engine undercover 1, thereby degrading the appearance of the boundary part between the composite sheet 4 and the resin layer 5.

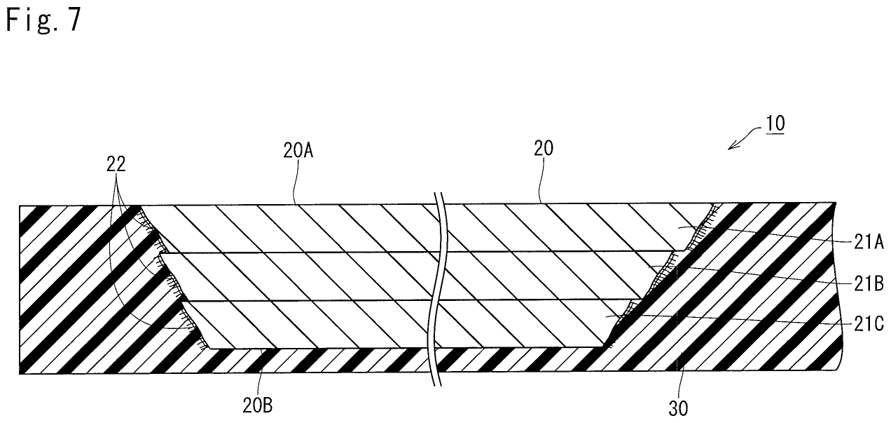

According to the method for producing the engine undercover 10 of this embodiment, the first fiberglass cloth 21A of the plurality of fiberglass cloths 21 positioned closest to the front side 20A of the composite sheet 20 is larger than the second and third fiberglass cloths 21B and 21C and covers the second and third fiberglass cloths 21B and 21C entirely from the front side 20A when the composite sheet is set inside the mold 80. Therefore, even when the fiberglass cloths 21 are displaced during the molding as shown in FIG. 7, the second and third fiberglass cloths 21B and 21C can hardly stick out of the first fiberglass cloth 21A. This minimizes the possibility of the end faces of the second and third fiberglass cloths 21B and 21C or glass fibers of loose glass threads 22 from their end faces showing on the surface of the engine undercover 10, so that the appearance of the boundary part between the composite sheet 20 and the resin layer 30 can be improved.

The production method described above of the engine undercover 10 of this embodiment is possible and can provide the effects described above especially because the first fiberglass cloth 21A is larger than the second and third fiberglass cloths 21B and 21C.

Since the three fiberglass cloths 21 are made in one piece by the resin 23 when the composite sheet 20 is placed in the mold 80, it is easier to set the composite sheet 20 in the mold 80 than when the three fiberglass cloths 21 are separate. The first fiberglass cloth 21A of the composite sheet 20 is made larger than the second and third fiberglass cloths 21B and 21C by diagonally cutting the outer edges of the three fiberglass cloths 21 made in one piece by the resin 23. Therefore, it is easier to make the first fiberglass cloth 21A larger than the second and third fiberglass cloths 21B and 21C than by cutting fiberglass cloth 21 to different sizes and then stacking them one upon another to make them in one piece.

When fiberglass cloth 21 is used in the composite sheet 20, as in this embodiment, it is possible that, if the glass fibers of the fiberglass cloth 21 show on the surface of the engine undercover 10, the glass fibers will reflect light and be more conspicuous than, for example, carbon fibers. According to the method for producing the engine undercover 10 of this embodiment, as described above, the possibility of the glass fibers showing on the surface of the engine undercover 10 is reduced. Namely, the composite sheet 20 composed of fiberglass cloth 21 can exploit the effect described above more.

In the engine undercover 10 of this embodiment, the composite sheet 20 that is more rigid than the resin layer 30 is fixed such as to face the outside of the vehicle 100, so that damage by a bouncing stone or the like can be minimized.

### Other Embodiments

The present disclosure is not limited to the embodiment described above. Other embodiments such as those described below, for example, are also included in the technical scope of the present disclosure, and various other changes can be made without departing from the scope of the subject matter.

(1) While three fiberglass cloths 21 are stacked upon one another as the composite sheet 20 in the embodiment described above, there may be two, or four or more cloths.

(2) While the plurality of fiberglass cloths 21 are made in one piece by the resin 23 in the embodiment described above, the composite sheet 20 may be formed by placing a plurality of separate fiberglass cloths 21 one upon another in the mold 80.

(3) While the plurality of fiberglass cloths 21 are first fixed in one piece by the resin 23 and the outer edges are cut diagonally in the embodiment described above, the first fiberglass cloth 21A may be cut beforehand to a larger size than the second and third fiberglass cloths 21B and 21C before being fixed in one piece.

(4) While any of the three fiberglass cloths 21 on the deeper side than the others is smaller in the embodiment described above, the second fiberglass cloth 21B and the third fiberglass cloth 21C may be of the same size as long as the first fiberglass cloth 21A is larger than the second and third fiberglass cloths 21B and 21C.

(5) While fiberglass cloth 21 made of glass fibers is used for the composite sheet 20 in the embodiment described above, other cloths such as carbon fiber cloth, chemical fiber cloth, or natural fiber cloth may also be used. These cloths (including the fiberglass cloth 21) may be a woven cloth, or a non-woven cloth or UD (unidirectional fabric).

(6) While the resin molded article of the present disclosure is an engine undercover 10 in the embodiment described above, it may be other car components such as battery case, oil pan, pillar, and so on, or any component of various electric appliances.

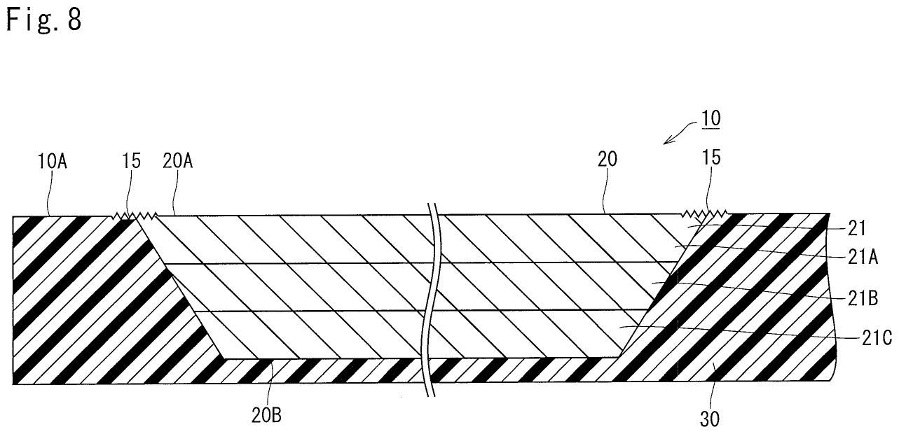

(7) The composite sheet 20 may be provided with a textured part 15 having surface irregularities in a band-like region including the boundary of the outer edges of the composite sheet 20 as shown in FIG. 8. This way, end faces of the fiberglass cloth 21 or loose glass fibers sticking out from the end faces that may be showing on the surface of the engine undercover 10 can be made less obvious, and the appearance of the boundary part between materials can be improved. Texturing alone can provide this effect.

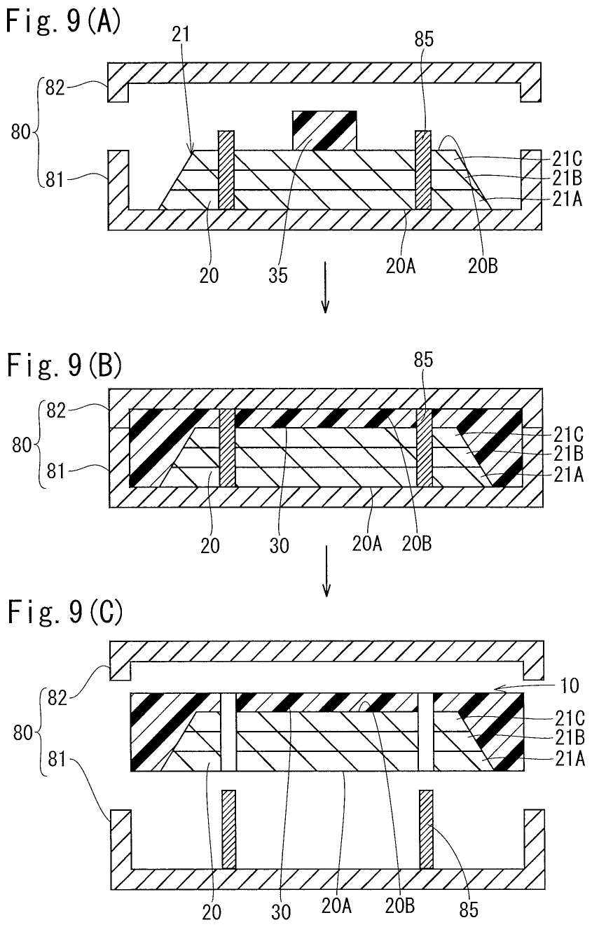

(8) The mold 80 may be configured to include pins 85 as shown in FIG. 9 so that the composite sheet 20 is retained with the pins 85 during the molding.

(9) The resin molded article may be produced by insertion molding.

(10) While polypropylene (PP) is used as the thermoplastic resin for the resin 23 and resin layer 30 in the embodiment described above, any thermoplastic resin is generally applicable. Examples include: polyolefin resins such as polyethylene (PE), polybutylene, 4-methyl-1-pentene and the like; polyester resins such as polyethylene terephthalate (PET), polybutylene terephthalate (PBT), poly trimethylene terephthalate (PT), polyethylene naphthalate, liquid crystalline polyester, polyactic acid (PLA) and the like; polyether resins such as polyether ketone (PEK), polyether ether ketone (PEEK), polyphenylene ether (PPE), polyether ketone ketone (PEKK) and the like; polyamide resins (PA) such as PA6, PA66, PA11, PA12, PA6T, PA9T, MXD6 and the like; acrylic resins such as polymethyl methacrylate (PMMA) and the like; epoxy resins, polycarbonate resins (PC), fluoropolymer resins, liquid crystal polymers (LCP), phenolic resins, phenoxy resins, polystyrene resins, polyurethane resins, as well as polyacetal (POM), polyphenylene sulfide (PPS), polyoxymethylene (POM), polyvinyl chloride (PVC), polyphenylene sulfide (PPS), polyphenylene ether (PPE), modified polyphenylene ether (PPE), polyimide (PI), polyamideimide (PAI), polyetherimide (PEI), polysulfone (PSU), modified PSU, polyethersulfone (PES), polybutadiene acrylate polyketone (PK), polyether nitrile (PEN), and the like. The resin may also be composed of a copolymer or any of the resins listed above that is modified, or a blend of two or more resins.

(11) Any thermosetting resin is also generally applicable as the resin 23 and resin layer 30. Examples include phenol-formaldehyde resin, urea-formaldehyde resin, melamine-formaldehyde resin, unsaturated polyester resin, epoxy resin, silicon resin, polyurethane resin, and the like.

(12) The resin 23 of the composite sheet 20 and the resin layer 30 may be made of the same resin, or of different resins.

(13) While the resin layer 30 in the embodiment described above contains glass fibers, the layer need not contain glass fibers and may be made of resin alone.

(14) While the composite sheet 20 is cut diagonally all around the outer edges in the embodiment described above, if it is known that the cloths are prone to displace in a particular direction due to the shape or the like of the resin molded article, the sheet may be cut only in this part.

(15) The plurality of fiberglass cloths 21 of the composite sheet 20 may be stacked up first and impregnated with resin, or, may each be separately impregnated and then made in one piece by applying heat.

### DESCRIPTION OF THE REFERENCE NUMERAL

10 Engine undercover
20 Composite sheet
21 Fiberglass cloth
21A First fiberglass cloth
23 Resin
30 Resin layer
35 Resin block
80 Mold

1-9. (canceled)

10. A method for producing a resin molded article, the method comprising:
placing a block-shaped second resin on a backside of a composite sheet within outer edges, the composite sheet being made up of a plurality of stacked fiber sheets impregnated with a first resin; and
pressing the composite sheet and the second resin by a heated mold, to produce a resin molded article having the composite sheet embedded in a part of a surface of a resin layer of the second resin that extends to sides of the composite sheet,
wherein
the composite sheet is formed such that a first fiber sheet of the plurality of fiber sheets positioned closest to a front side of the composite sheet is larger than other fiber sheets and covers the other fiber sheets entirely from the front side, when placed inside the mold.

11. The method for producing a resin molded article according to claim 10,
wherein the mold is provided with a fixing pin to retain the composite sheet.

12. The method for producing a resin molded article according to claim 10, wherein
the composite sheet is formed into a structure in which the plurality of fiber sheets are fixed in one piece by the first resin and the composite sheet has side faces inclined with respect to the front side and the backside so that the front side of the composite sheet is wider than the backside, before being placed inside the mold.

13. The method for producing a resin molded article according to claim 11, wherein
the composite sheet is formed into a structure in which the plurality of fiber sheets are fixed in one piece by the first resin and the composite sheet has side faces inclined with respect to the front side and the backside so that the front side of the composite sheet is wider than the backside, before being placed inside the mold.

14. The method for producing a resin molded article according to claim 12, wherein
the plurality of fiber sheets of the composite sheet are first fixed in one piece by the first resin, after which the composite sheet is cut around outer edges so that side faces of the composite sheet are inclined with respect to the front side and the backside.

15. The method for producing a resin molded article according to claim 13, wherein
the plurality of fiber sheets of the composite sheet are first fixed in one piece by the first resin, after which the composite sheet is cut around outer edges so that side faces of the composite sheet are inclined with respect to the front side and the backside.

16. The method for producing a resin molded article according to claim 12, wherein
the first fiber sheet is cut to a larger size than the other fiber sheets before being fixed to the other fiber sheets in one piece.

17. The method for producing a resin molded article according to claim 13, wherein
the first fiber sheet is cut to a larger size than the other fiber sheets before being fixed to the other fiber sheets in one piece.

18. The method for producing a resin molded article according to claim 10, wherein
the fiber sheet is made of glass fibers.

19. The method for producing a resin molded article according to claim 11, wherein
the fiber sheet is made of glass fibers.

20. The method for producing a resin molded article according to claim 12, wherein
the fiber sheet is made of glass fibers.

21. The method for producing a resin molded article according to claim 14, wherein
the fiber sheet is made of glass fibers.

22. The method for producing a resin molded article according to claim 16, wherein
the fiber sheet is made of glass fibers.

23. The method for producing a resin molded article according to claim 10, wherein
the resin molded article is molded such as to include a fixing part to fix the resin molded article in a state covering a lower side of a vehicle engine, with the fiber sheets facing downward.

24. The method for producing a resin molded article according to claim 11, wherein
the resin molded article is molded such as to include a fixing part to fix the resin molded article in a state covering a lower side of a vehicle engine, with the fiber sheets facing downward.

25. The method for producing a resin molded article according to claim 12, wherein
the resin molded article is molded such as to include a fixing part to fix the resin molded article in a state covering a lower side of a vehicle engine, with the fiber sheets facing downward.

26. The method for producing a resin molded article according to claim 14, wherein
the resin molded article is molded such as to include a fixing part to fix the resin molded article in a state covering a lower side of a vehicle engine, with the fiber sheets facing downward.

27. The method for producing a resin molded article according to claim 16, wherein
the resin molded article is molded such as to include a fixing part to fix the resin molded article in a state covering a lower side of a vehicle engine, with the fiber sheets facing downward.

28. A resin molded article comprising:
a composite sheet made up of a plurality of stacked fiber sheets impregnated with a first resin, the composite sheet being embedded in a part of a surface of a resin layer of a second resin that extends to sides of the composite sheet, wherein a first fiber sheet of the plurality of fiber sheets positioned closest to a front side of the composite sheet is larger than other fiber sheets; and
a textured part that is a band-like region having surface irregularities and extending along and including a boundary of outer edges of the composite sheet in a surface of the resin molded article.

29. The resin molded article according to claim 28, comprising a fixing part to fix the resin molded article in a state covering a lower side of a vehicle engine, with the composite sheet facing downward.
